(19) United States
(12) Patent Application Publication
(10) Pub. No.: US 2005/0027602 A1
(43) Pub. Date: Feb. 3, 2005

(54) Method and system for facilitation of a remote transaction

(76) Inventor: Wassim Haddad, Montreal (CA)

Correspondence Address: HEWLETT-PACKARD COMPANY;Intellectual Property Administration, P.O. Box 272400, Fort Collins, CO, 80527-2400, US

(21) Appl. No.: 10/834,464

(22) Filed: Apr. 29, 2004

(30) Foreign Application Priority Data
Apr. 30, 2003 (GB) 0309960.3

(51) Int. Cl. G06F 17/60

(52) U.S. Cl. 705/17; 705/18; 705/44; 705/42

(57) ABSTRACT

A method of enabling a customer to carry out a transaction with a remote processing apparatus from a local processing apparatus connected to the remote processing apparatus via a first, unsecure, network, said method comprising the following steps: sending a request to initiate the transaction from the local processing apparatus to the remote processing apparatus across the first network; causing the remote processing apparatus to respond to said request by transmitting a response to said request to said local processing apparatus requesting specified information; and transmitting a response to said response containing said specified information in a transmission from the local processing apparatus to the remote processing apparatus wherein at least one of said response to said request and said response to said response are sent via at least one second network, different from the first.

### FIELD OF THE INVENTION

This invention relates to providing a method and related systems and processing apparatus for facilitating a transaction with a remote processing apparatus connected to a local processing apparatus via a non-secure network, and more specifically, such methods and apparatus arranged to complete a financial transaction.

### BACKGROUND OF THE INVENTION

Financial transactions across un-secure networks, such as the Internet are becoming more common and widely accepted. However, such transactions are still not as widely accepted and used as is desirable. This lack of acceptance affects both companies offering goods and services over such networks whose business may be hampered by the lack of acceptance and also by the public at large who are prevented the use of such transactions by the perceived and/or real lack of security.

Presently, an Internet based transaction will generally follow the following outline and is shown in FIG. 1. A potential customer will access a virtual store using a local processing apparatus 4, generally presented by a web page provided on the World Wide Web, stored on a server 4 and accessed across the Internet 6. Once accessed the potential customer will browse the available goods and services and select one or more for purchase. The selected goods must then be paid for and typically this is by the now customer entering his/her credit card details on to the computer, or other access device, that they are using to look at the virtual store and transmitting those details across the network 8,10. Because the Internet 6 is generally un-secure these credit card details are potentially accessible by third parties and once accessed the credit account defined by those details is open to abuse by that third party. Such fraud is costly not only to customers and potential customers, but also to businesses.

Prior attempts to make such transactions more secure, as outlined in documents such a WO 9638799, have included only transmitting a portion of the credit card details across the network.

Other prior art includes U.S. Pat. No. 5,878,337 which shows a system in which a validating communication is transmitted to a device (typically a mobile telephone), other than a terminal (such as a credit card point of sale terminal) that initiates the transaction. The owner of the device may then block the transaction by making an appropriate response to the validating communication.

### SUMMARY OF THE INVENTION

According to a first aspect of the invention there is provided a method of enabling a customer to carry out a transaction with a remote processing apparatus from a local processing apparatus connected to the remote processing apparatus via a first, unsecure, network, said method comprising the following steps:
i. sending a request to initiate the transaction from the local processing apparatus to the remote processing apparatus across the first network;
ii. causing the remote processing apparatus to respond to said request by transmitting a response to said request to said local processing apparatus requesting specified information; and
iii. transmitting a response to said response containing said specified information in a transmission from the local processing apparatus to the remote processing apparatus
   wherein at least one of said response to said request and said response to said response are sent via at least one second network, different from the first.

Such a method is advantageous because information is transmitted in a manner prescribed in the response and need not therefore, be associated with the request made to the remote processing apparatus. It will of course be appreciated that the information may include credit card details, debit card details, and any other form of credit or debit details used to make a purchase. The term information may however include any other information and in particular may include information providing a reference that uniquely identifies a customer's account from which funds to pay a seller for goods or services will be transferred, and/or information that confirms the identity of a user of the local processing apparatus.

The local processing apparatus may be any apparatus capable of establishing a connection (a connection over which data can be exchanged) with a remote processing apparatus. This is preferably a direct connection by which we mean that the address of the recipient of data is known to the sender who transmits it directly across the network to that address, eg an email address or a telephone number. The skilled person will appreciate that the number of types of such apparatus is increasing and currently includes any of the following non-exhaustive list: PDA's, telephones (both mobile and fixed line), laptop computers, notebook computers, watches, desktop computers, televisions, and the like.

The requested predetermined information may also comprise information that verifies the identity of a user of the local processing apparatus. Such information may comprise any, of the following not exhaustive list: passwords, specified multimedia files (both pre-existing and newly created), signatures, answers to questions, and similar information. Such information is advantageous because it allows the identity of a user of the local processing device to be checked. This may help to improve the security since it will not simply be possible to steal a user's local processing device (e.g. PDA, mobile telephone) and allow method to be performed; the person stealing the local processing apparatus may still not be able to transmit said predetermined information, requested in the response, in a transmission from the local processing apparatus to the remote processing apparatus unless he/she knows the information.

Further, the first network may be the Internet and the remote processing apparatus may be a server providing information to the first network.

It may be advantageous if the at least one second network comprises a packet switched network, because such a network provides greater flexibility in the connection between the local processing apparatus and the remote processing apparatus. Indeed, using a packet switched network in this manner may allow the one or both of the response to the request and the response to the response to be transmitted via a plurality of networks rather than a single network.

Using a plurality of networks may be advantageous because it adds greater flexibility to how the response to the request and the response to the response can be sent to the local processing apparatus. For example, should the local processing apparatus comprise a desktop computer it is likely that an email connection will be available, but it may perhaps be unlikely that a telephone network connection thereto will be available. Therefore, the response to the request sent to the local processing may be sent from the remote processing apparatus via a telephone network, perhaps via an MMS message. Since, in this example, the local processing apparatus does not have a connection to the telephone network it will not be capable of receiving this message. Therefore, the message may be directed to the service provider to which the local processing apparatus connects and is converted to an email that is then forwarded to the local processing apparatus. Therefore, this response to the response will be transmitted via two different networks: the telephone network, and the network linking the local processing apparatus to its service provider. However, the response to the response is still likely to be secure and difficult to intercept since it is likely to have been transmitted via the telephone network for the majority of its path. It may be harder to intercept a communication sent from the server of the service provider to the local processing apparatus than a communication sent across a network such as the Internet at large. It will be appreciated that it is possible to send an MMS message to an email address.

The term unsecure network is intended to cover networks in which data is at risk from third parties. For example, the data may be intercepted, accessed on a server without authorisation, obtained following a confidence trick (such by sending apparently valid emails requesting responses giving away account details and the like) or any other means in which the data is obtained undesirably by a third party. In particular the first, unsecure, network may comprise the Internet.

Conveniently, communications sent across the second network may comprise MMS messages. Such messages are advantageous because they may comprise data according to a plurality of different formats and as such may provide a stronger authentication than prior art systems. It is conceivable that messages sent over the second network could comprise any other format. For example the communications may comprise SMS messages. Such SMS messages are of course much shorter than MMS messages and therefore may not be capable of providing as strong an authentication as an MMS message.

According to a second aspect of the invention there is provided a system arranged to provide transactions comprising a local processing apparatus connected via a first, unsecure, network to a remote processing apparatus and each of the remote processing apparatus and local processing apparatus being capable of communicating with each other via a second network, different from the first, the local processing apparatus being arranged to transmit a request to initiate the transaction across the first network to the remote processing apparatus, the remote processing apparatus being arranged to respond to said request by transmitting a response to the local processing apparatus and the local processing apparatus further being arranged to transmit information requested in the response in a transmission to the remote processing apparatus; wherein at least one of said response and said transmission are made using the second network.

Such a system is advantageous because it may facilitate transactions across the unsecure network, which it will be appreciated in intended to cover networks in which data is at risk from third parties. For example, the data may be intercepted, accessed on a server without authorisation, obtained following a confidence trick (such by sending apparently valid emails requesting responses giving away account details and the like) or any other means in which the data is obtained undesirably by a third party.

According to a third aspect of the invention there is provided a processing apparatus comprising a first transmitting means and a first receiving means arranged respectively to transmit and receive data across a first, unsecure, network, a second transmitting means and a second receiving means arranged respectively to transmit and receive data across a second network, different from the first network, and a processing means, the first receiving means being arranged to receive a request to initiate a transaction and pass said request to said processing means, said processing means being arranged to process said request and cause one of said first and said second transmitters to transmit a response and one of said first and said second receiving means being arranged to receive a response thereto and pass said received response to said processing means and said processing means being arranged to determine if said transaction can proceed following processing of said received response; wherein at least one of said second transmitter and said second receiver is used to, respectively, transmit or receive.

Such a processing apparatus may be provided for example by a server, or the like.

According to a fourth aspect of the invention there is provided a method of enabling a customer to carry out a transaction comprising receiving a request to initiate the transaction across an unsecure first network connection, processing said request and generating a response thereto which is subsequently transmitted and receiving a response to said transmitted response and processing said received response in order to determine whether said transaction should continue; wherein at least one of said response to said request and said transmitted response are sent across a second network different from the first.

According to a fifth aspect of the invention there is provided a processing apparatus arranged to generate a request to initiate a transaction and to transmit said request using a first transmitting means across a first, unsecure, network, said processing apparatus further comprising a first receiving means arranged to receive data across said first network and a second receiving means arranged to receive data across a second network different from the first network wherein one of said first and said second receiving means are arranged to receive a response to said request and the processing means being arranged to generate a response to said response containing information, requested in said received response, and to transmit said response to said received response using one of a first transmitter arranged to send data across said first network and a second transmitter arranged to send data across said second network; wherein at least one of said response to said request and said response to said response are transmitted across said second network.

Such an apparatus may be any processing apparatus capable of communicating with a remote processing apparatus. For example the processing means may be a computer, a telephone, a PDA, a television, or the like.

According to a sixth aspect of the invention there is provided a method of enabling a customer to carry out a transaction comprising generating and transmitting a request to initiate the transaction across an unsecure first network connection, receiving a response to said request, generating a response to said received response and including in said response to said received response information requested in said response and transmitting said generated response; wherein at least one of said response to said request and said response to said response are transmitted via a second network, different from said first network.

According to a seventh aspect of the invention there is provided a computer readable medium containing instructions which when loaded on to a computer cause that computer to perform the method of any of the first, fourth or sixth aspects of the invention.

According to an eighth aspect of the invention there is provided a computer readable medium containing instructions which when loaded onto a computer cause that computer to function as the processing apparatus of the third or fifth aspects of the invention.

According to a ninth aspect of the invention there is provided a computer readable medium containing instructions which when loaded onto a computer cause that computer to function as the local and/or remote processing apparatus of the first aspect of the invention.

The computer readable medium of any of the seventh, eighth or ninth aspects of the invention may comprise any of the following: a floppy disk, a hard drive, a CD ROM (including RW), a DVD ROM/RAM (including +RW/−RW), any form of magneto/optical storage, magnetic tape, memory, a transmitted signal (including an Internet file transfer, ftp, or the like), a wire, or any other suitable medium.

### BRIEF DESCRIPTION OF THE DRAWINGS

There now follows by way of example only a detailed description of the present invention with reference to the accompanying drawings in which:

FIG. 1 shows a prior art arrangement for making a payment across a network, such as the Internet;

FIG. 2 schematically shows a remote processing apparatus, such as a server, used in embodiments of the invention;

FIG. 3 schematically shows the communications used in embodiments of the present invention;

FIG. 4 shows a number of potential local processing apparatus that may be used to access a remote processing apparatus;

FIG. 5 shows a flow chart for a first embodiment of the invention; and

FIG. 6 shows a flow chart for a second embodiment of the invention.

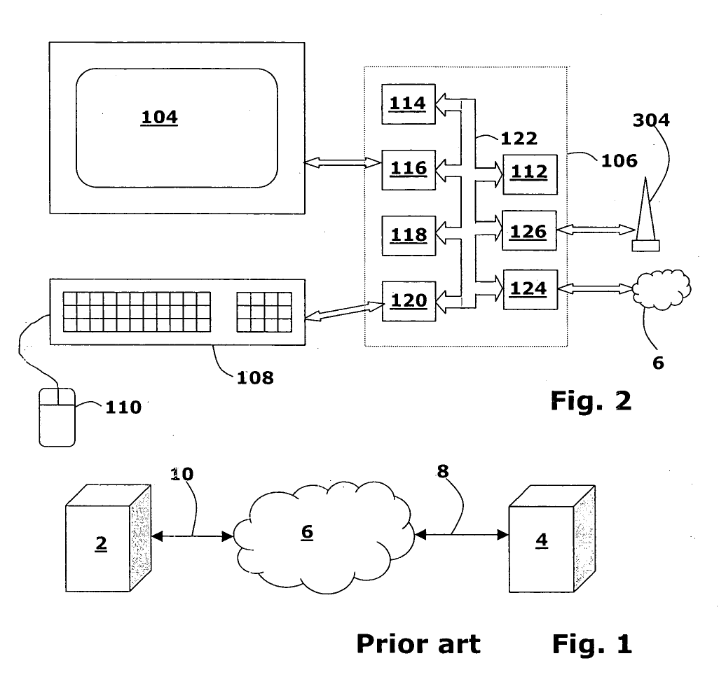

### DETAILED DESCRIPTION OF THE DRAWINGS

Embodiments of this invention allow access to a remote processing apparatus across a network. An example of such an processing apparatus (in this example, a server 100) is shown in FIG. 2 and comprises a display 104, processing circuitry 106, a keyboard 108, and mouse 110. The processing circuitry 106 further comprises a processing means 112, a hard drive 114, a video driver 116, memory 118 (RAM and ROM) and an I/O subsystem 120 which all communicate with one another, as is known in the art, via a system bus 122. The processing means 112 typically comprises at least one INTEL™ PENTIUM™ series processor, running at generally between 2 GHz and 2.8 GHz (although it is of course possible for other processors to be used). The remote processing apparatus may of course be any other type of computer and could for example be a mainframe computer; a mini-computer; a micro-computer; or any other suitable processing apparatus including any computer or computer system.

As is known in the art the ROM portion of the memory 118 contains the Basic Input Output System (BIOS) that controls basic hardware functionality. The RAM portion of memory 118 is a volatile memory used to hold instructions that are being executed, such as program code, etc. The hard drive 114 is used as mass storage for programs and other data.

Other devices such as CDROMS, DVD ROMS, network cards, etc. could be coupled to the system bus 122 and allow for storage of data, communication with other computers over a network, etc.

The server 100 further comprises a transmitting/receiving means 124 which is arranged to allow the server 100 to communicate using the Internet 6 (which provides a first, unsecure, network). The means 124 also communicates with the processing means 112 via the bus 122. A transmitting/receiving means 126 is also provided which is capable of communicating with a second network 304, as will be described hereinafter.

The server 100 could have the architecture known as a PC, originally based on the IBM™ specification, but could equally have other architectures. The server may be an APPLE™, or may be a RISC system, and may run a variety of operating systems (perhaps HP-UX, LINUX, UNIX, MICROSOFT™ NT, AIX™, or the like).

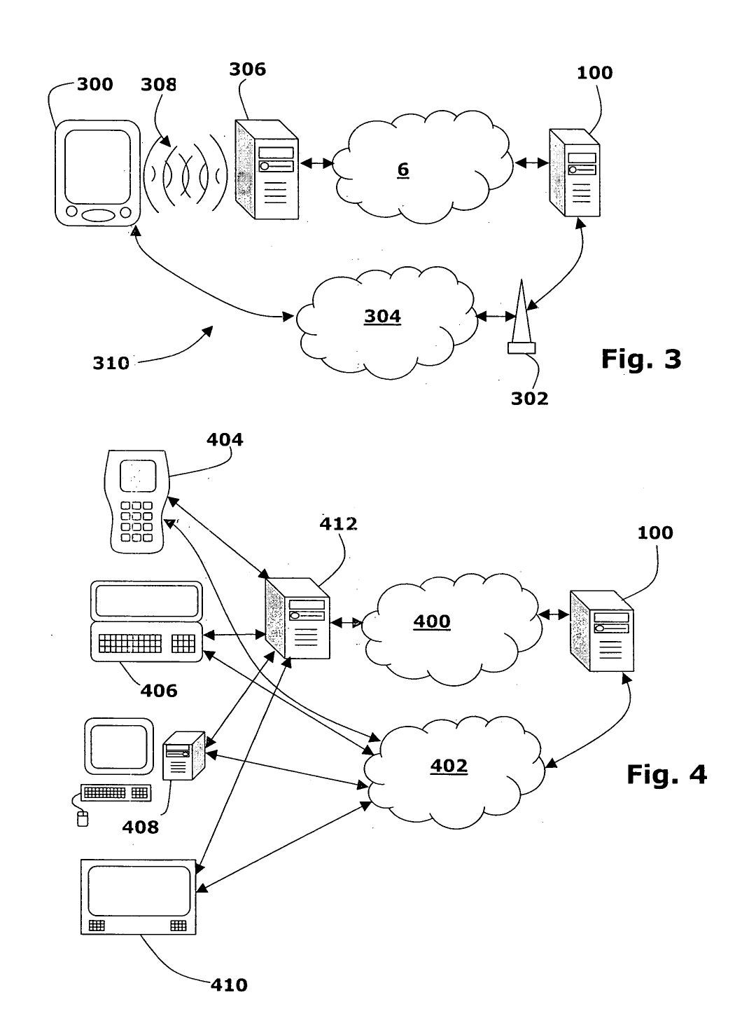

As can be seen from FIG. 3 a local processing apparatus 300 capable of communicating with the remote processing apparatus 100 is provided. In the embodiment shown the local processing apparatus is a PDA, such as a COMPAQ iPAQ™ equipped with a UMTS connection 310 capability and a WIFI (IEEE 802.11) connection 308 capability. However, as described later the local processing apparatus could be a number of other devices.

As the skilled person will appreciate the Compaq™ iPAQ™ operates using the Microsoft™ PocketPC™ operating system, and runs Microsoft™ Pocket Explorer as its means of communicating with the server 100 across the Internet 6 (in conjunction with the World Wide Web). The iPAQ™ has a virtual keyboard, provided via touch screen input, and can access the web, etc. using modem, or network cards connected through its PC card slot or via its infrared link, or Bluetooth™ links. However, in this embodiment access to the Internet is provided by the WIFI link 308 to a server 306 which subsequently connects to the Internet 6.

The iPAQ™ is also capable of receiving communications via the UMTS (sometimes referred to as 3G) connection 310. The UMTS connection 310 is represented, in the Figure, by the transmitter/receiver 302 together with the cloud 304 representing the transmitted signal. Thus, the PDA 300 is capable of receiving communications from external sources using two, generally unrelated, communication networks.

The skilled person will appreciate the existence of the MMS (Multi-media Messaging Service) protocol which is capable of transmitting messages containing data representing any form of multi-media. For example the data transmitted by an MMS message may represent graphics, audio samples, images, video clips, streamed data, allow synchronised presentations to take place and the like. Indeed, the initial specification of MMS has been defined to work with the following data-formats:

| | |
|---|---|
| image: | JPEG, GIF 89a, WBMP |
| video: | ITU-T, H.263, MPEG 4 simple profile |
| audio: | MP3, MIDI, WAV, AMR/EFR-for voice. |

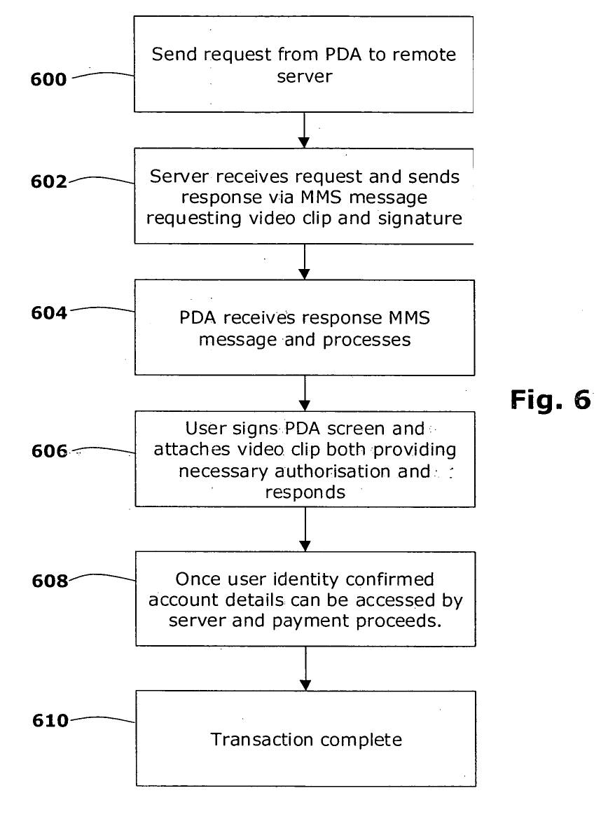

In use of the system outlined in FIGS. 3 and 6 a user may access Web pages held on the server 100 using the PDA 300 via the WIFI connection 308 to the server 306 to the Internet 6. These web pages may include e-commerce sites from which the user may wish to purchase goods. For such sites, the user may browse the site to make his/her selection using Microsoft™ Pocket Explorer. Once the goods have been selected they will typically be added to a “shopping basket”, although any other form of selection may be used by the site.

As is common with such e-commerce sites when the user has finished making his/her selections they proceed to a checkout in which payment for the selected goods is arranged, following the sending of a request from the PDA 300 to the server 100 to purchase the goods; i.e. a request to initiate a transaction 600. Again, any mechanism other than a checkout for arranging for payment of the selected goods may be contemplated.

Once the PDA 300 has sent a communication to the server 100 indicating that they a purchase is desired then the server causes a response in the form of an MMS message to be sent 602 to the PDA 300 via the UMTS connection 304; a separate network to the Internet 6 connection. Thus, even if the request is intercepted across the Internet 6 it will be hard to intercept the response since it is sent via an MMS message.

In this embodiment the response contains a list of questions to try and provide a strong authentication of the users identity and may include any of the following: a password, a geographical position, a multi-media file (which may be predetermined), audio and/or video authentication, a finger print scan, or any other suitable means of identifying the user of the PDA 300).

The file attached to the response to the remote processing apparatus may be a pre-existing file. However, it will be appreciated that the user could create the file using the local processing apparatus 300. For example the local processing apparatus 300 may comprise a camera which is arranged to take still and/or video images which could make up the file that is attached. Alternatively, the local processing apparatus 300 could be arranged to make any of the different types of media files discussed herein. The local processing means may comprise a GPS module that allows the location of the device to be determined and provided to authenticate the location of the apparatus.

The user of the PDA 300 responds 604 to this response from the server 100 by replying with a further MMS message. In this embodiment, since the iPAQ 300 is provided with a touch sensitive screen the user signs a portion 606 of the MMS message, answers the questions and attaches a video clip 606 that has been asked for by the server 100. It will be appreciated that in other embodiments, the server 100 may ask additional and/or alternative and/or fewer questions of the user.

Indeed, in some embodiments the response message from the remote processing apparatus 100 to the local processing apparatus 300 may specify at what time the response to the remote processing apparatus 300 should be sent. Indeed, the timing of subsequent communications (e.g. the response from the remote processing apparatus and the response from the local processing apparatus) may be determined from the request sent to the remote processing apparatus 100. Such arrangements may make the method more secure since it will be harder to intercept the communications.

Conveniently, the questions posed by the server are selected on an automatic, generally random, basis from a list of predetermined questions to which the server 100 has answers. The answers may well have been provided to the server when the user created an account on that server (or accessed by that server 100) in order to process the transaction.

The server 100 processes the MMS message that it receives from the PDA 300 to determine whether the identity of the user has been verified (e.g. are the answers to the questions correct? Is the signature correct? Is the multimedia file the correct one?). Once the identity of the user is verified then payment for the goods may proceed 608 and the server 100 can access pre-stored payment details, using a payment means, in order to collect money for the selected goods/services and in this embodiment the transaction terminates 610.

It will be appreciated that the pre-stored payment details may include credit card details, debit card details, and any other form of credit or debit details used to make a purchase (e.g. bank account details). Indeed, in some embodiment the MMS message sent from the PDA 300 to the server 100 may contain credit card information in addition to and/or instead of the identity verification. Such details provide a means of making a payment to the server 100.

As represented by FIG. 4 the local device 300 need not be a PDA and could be any form of device capable for communicating with the server 100 via a first network 400 and a second network 402. A possible list of such devices, which is not intended to be exhaustive, includes: a telephone (show as a mobile telephone in the Figure, but not necessarily so) 404; a notebook computer and/or PDA with keyboard 406; a computer such as a PC, apple, or the like 408; a television 410. Each of these devices would generally connect to a server, such as that shown at 412, in order to connect to a network such as the Internet 400. Other suitable local processing apparatus may include any of the following non-exhaustive list: watches, voice portals, and the like

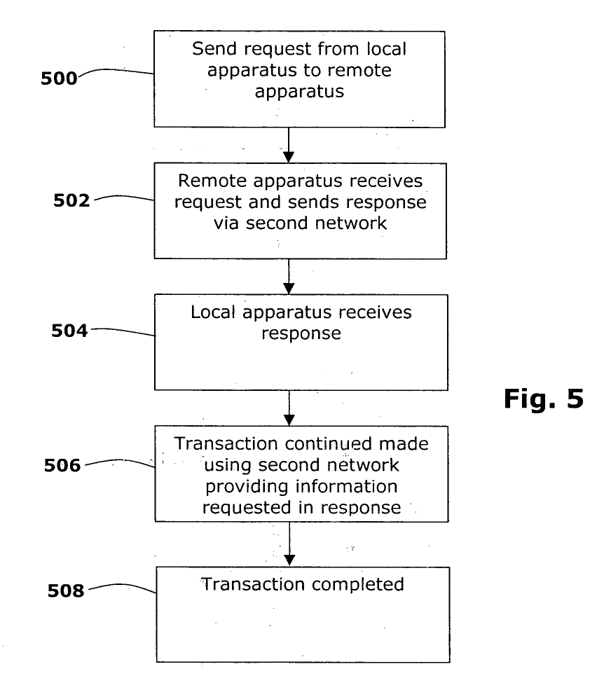

A generic flow chart for the process described above can be seen in FIG. 5, in which a request to initiate a transaction is generated on a local processing apparatus 500 and transmitted across a first, unsecure, network. The remote processing apparatus 502 receives this request and sends a response thereto via a second network. The local processing apparatus receives this response 504 and generates 506 a response thereto which includes information requested in the response sent from the remote processing apparatus. In the embodiment represented by FIG. 5, the response to the response completes the transaction 508.

Although the above embodiments describe the second network as comprising a UMTS connection it could of course be any network capable of connecting (i.e. allowing data to pass therebetween) the remote and local processing apparatus. It is convenient if the second network is a wireless network such as UMTS, GPRS, or the like, since this may increase the security of the messages. However, this need not be the case. It is known for users to hold accounts with different Internet Service Providers (ISP's) and some embodiments of the invention may send the request and response messages across the same infrastructure (e.g. the Internet), but using a different ISP and so provide two different networks.

Further, it will be appreciated that the above embodiments talk about a first and a second network. It would of course be possible to for a communication (whether a response, or a request) to be sent via a plurality of different networks. For example, the response to the initial request may be sent to via a MMS message which is subsequently converted into an email for a portion of its journey. The advantages of the invention may be provided by the provision of a network connection which includes, or is predominately, a wireless connection, and in particular a wireless telephone connection.

1. A method of enabling a customer to carry out a transaction with a remote processing apparatus from a local processing apparatus connected to said remote processing apparatus via a first, unsecure, network, said method comprising the following steps:
i. sending a request to initiate said transaction from said local processing apparatus to said remote processing apparatus across said first network;
ii. causing said remote processing apparatus to respond to said request by transmitting a response to said request to said local processing apparatus requesting specified information; and
iii. transmitting a response to said response containing said specified information in a transmission from said local processing apparatus to said remote processing apparatus
wherein at least one of said response to said request and said response to said response are sent via at least one second network, different from said first network:

2. A method according to claim 1 wherein said at least one second network comprises a packet-switching network.

3. A method according to claim 1 wherein at least one of said response to said request and said response to said response are sent via a plurality of networks.

4. A method according to claim 1 wherein said specified data includes one of data arranged to identify a user of said local processing apparatus and data providing a means of making a payment.

5. A method according to claim 4 which comprises causing said remote processing apparatus to verify the identity of a user of said local apparatus by checking the information sent thereto in said response to said response.

6. A method according to claim 5 which comprises causing said remote processing apparatus to take a payment using a stored means of making a payment once the identity of a user has been verified.

7. A method according to any preceding claim which utilises at least one MMS message for said response to said request or said response to said response.

8. A method according to any preceding claim wherein said remote processing apparatus comprises a server. 15.

9. A system arranged to provide transactions comprising a local processing apparatus connected via a first, unsecure, network to a remote processing apparatus and each of said remote processing apparatus and said local processing apparatus further being capable of communicating with each other via a second network, different from said first, said local processing apparatus being arranged to transmit a request to initiate said transaction across said first network to said remote processing apparatus, said remote processing apparatus being arranged to respond to said request by transmitting a response to said request to said local processing apparatus requesting specified information and said local processing apparatus further being arranged to transmit said specified information in a response to said response in a transmission to said remote processing apparatus; wherein at least one of said response to said request and said response to said response are made using said second network.

10. A processing apparatus comprising a first transmitting means and a first receiving means arranged respectively to transmit and receive data across a first, unsecure, network, a second transmitting means and a second receiving means arranged respectively to transmit and receive data across a second network, different from the first network, and a processing means, said first receiving means being arranged to receive a request to initiate a transaction and pass said request to said processing means, said processing means being arranged to process said request and cause said second transmitting means to transmit a response to said request including a request for specified information, said second receiving means being arranged to receive a response to said response and pass said response to said response to said processing means and said processing means being arranged to determine if said transaction can proceed following processing of said response to said response.

11. An apparatus according to claim 10 wherein said second transmitter and second receiver are arranged to communicate via a packet-switching network.

12. An apparatus according to claim 10 wherein said processing means is arranged to add a request for data which includes one of data arranged to identify a user of the local processing apparatus and data providing a means of making a payment.

13. An apparatus according to claim 10 which includes payment means for effecting a financial transaction once said processing means has determined that said transaction can proceed.

14. An apparatus according to claims 10 wherein said first transmitting means and said first receiving means are arranged, respectively, to transmit and receive data across the Internet.

15. An apparatus according to claim 10 wherein said second transmitting and said second receiving means are arranged, respectively, to transmit and receive MMS messages.

16. A method of enabling a customer to carry out a transaction comprising receiving a request to initiate said transaction across an unsecure first network connection, processing said request and generating a response to said request which includes a request for specified information, which is subsequently transmitted and receiving a response to said response and processing said response to said response in order to determine whether said transaction should continue; wherein said response to said request and said response to said response are sent across a second network different from said first network.

17. A processing apparatus arranged to generate a request to initiate a transaction and to transmit said request using a first transmitting means across a first, unsecure, network, said processing apparatus further comprising a first receiving means arranged to receive data across said first network and a second receiving means arranged to receive data across a second network different from said first network wherein said second receiving means is arranged to receive a response to said request and said processing means is arranged to generate a response to said response containing specified information, requested in said received response, and to transmit said response to said response using a second transmitter arranged to send data across said second network.

18. A method of enabling a customer to carry out a transaction comprising generating and transmitting a request to initiate said transaction across an unsecure first network connection, receiving a response to said request, generating a response to said received response and including in said response to said response specified information requested in said response to said request and transmitting said response to said response; wherein both said response to said request and said response to said response are transmitted via a second network, different from said first network.

19. A computer readable medium containing instructions which when loaded on to a computer cause that computer to facilitate a transaction to a customer by causing said computer to:
receive a request to initiate said transaction across an unsecure first network connection, process said request and generate a response to said request which includes a request for specified information, which is subsequently transmitted and receive a response to said response and process said response to said response in order to determine whether said transaction should continue; wherein said response to said request and said response to said response are sent across a second network different from said first network
